(19) United States
(12) Patent Application Publication
(10) Pub. No.: US 2015/0151698 A1
(43) Pub. Date: Jun. 4, 2015

(54) METHOD FOR MANUFACTURING BUMPER BEAM UNIT FOR VEHICLE AND BUMPER BEAM UNIT MANUFRCTURED THEREBY

(71) Applicant: SUNGWOO HITECH CO., LTD., Busan (KR)

(72) Inventors: Mun Yong LEE, Busan (KR); Deok Hyun Kim, Busan (KR)

(73) Assignee: SUNGWOO HITECH CO., LTD., Busan (KR)

(21) Appl. No.: 14/139,949

(22) Filed: Dec. 24, 2013

(30) Foreign Application Priority Data
Dec. 4, 2013 (KR) 10-2013-0150241

(51) Int. Cl. B60R 19/18; B21B 15/00

(52) U.S. Cl. CPC B60R 19/18; B21B 15/0007

(57) ABSTRACT

A method of manufacturing a bumper beam unit of a vehicle, wherein the bumper beam unit includes a bumper beam formed through a roll forming process and a stay mounted at an end portion of the bumper beam is disclosed. The method may include: a cutout section forming step in which a cutout section is formed by cutting out an end portion of a rear portion of the bumper beam partially; a cutout section bonding step in which a bonding section is formed by bonding both cutout surfaces in a state of contacting the both cutout surfaces; and a stay bonding step in which a stay is bonded to end portions of a rear surface of the bumper beam corresponding to the bonding section.

### CROSS-REFERENCE TO RELATED APPLICATION

This application claims priority to and the benefit of Korean Patent

Application No. 10-2013-0150241 filed in the Korean Intellectual Property Office on Dec. 4, 2013, the entire contents of which are incorporated herein by reference.

### BACKGROUND OF THE INVENTION

(a) Field of the Invention

The present invention relates to a method of manufacturing a bumper beam unit for a vehicle and the bumper beam unit manufactured thereby. More particularly, the present invention relates to a method of manufacturing a bumper beam unit for a vehicle and the bumper beam unit manufactured thereby which overcomes the limitations occurring when curvatures are formed at both end portions of a bumper beam and achieves target crashworthiness of frontal sides of a vehicle body.

(b) Description of the Related Art

Generally, a bumper of a vehicle is a shock-absorbing unit which looks to occupant's safety by absorbing impact and minimizes deformation of a vehicle body when the vehicle collides with other vehicles or stationary objects. The bumpers are disposed on front and rear surfaces of the vehicle.

The bumper includes a bumper beam unit provided with a bumper beam disposed at a front portion or a rear portion of the vehicle in a width direction and a stay, and mounted at side members of the vehicle body through the stay, an energy absorber disposed in front of the bumper beam and absorbing impact, and a bumper cover enclosing the bumper beam and the energy absorber.

Recently, a curved frontal side shape is applied to the vehicle so as to achieve good appearance and induce a customer to buy the vehicle.

However, the bumper beam having predetermined curvatures at both side portions thereof is hard to be applied to the vehicle since the both end portions of the bumper beam interferes with other components. Therefore, reinforcing members are mounted at both end portions of the bumper beam so as to make the predetermined curvatures and meet crash regulations such as frontal offset crash test, small overlap crash test, frontal side impact test, and so on.

FIG. 1 is a perspective view of a conventional bumper beam unit for a vehicle, and FIG. 2 is an exploded view of a conventional bumper beam unit for a vehicle.

Referring to FIG. 1 and FIG. 2, the conventional bumper beam unit for a vehicle includes a bumper beam 101, a side reinforced bracket 103, a bracket 105, and a stay 107.

The bumper beam 101 is formed to have a straight tubular shape having a closed cross-section through a roll forming process. After that, the bumper beam 101 is formed to have a predetermined curvature along a length direction thereof by a curvature former (not shown).

In addition, the side reinforced bracket 103 is mounted at an end portion of a front surface of the bumper beam 101.

In addition, the bracket 105 is mounted at the end portion of a rear surface of the bumper beam 101.

That is, the bracket 105 is coupled with the side reinforced bracket 103 so as to form the end portion of the bumper beam 101.

At this time, end portions of the side reinforced bracket 103 and the bracket 105 are curved rearward such that curvature radii of the side reinforced bracket 103 and the bracket 105 are smaller than a curvature radius of the bumper beam 101. The side reinforced bracket 103 and the bracket 105 are used as reinforcing members for the curved frontal side shape of the vehicle.

In addition, the stay 107 is coupled to a rear surface of the bracket 105.

The conventional bumper beam unit corresponds to each of front and rear curved shapes of the vehicle so as to absorb impact due to vehicle crash in a length direction and minimize deformation of the vehicle body.

However, since the conventional bumper beam unit uses the side reinforced brackets 103 and the brackets 105 at both end portions of the bumper beam 101 so as to be corresponded to the curved frontal side shape of the vehicle body and meet crash regulations, the number of components may increase. In addition, since shapes of other components should be changed, manufacturing cost may rise.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of manufacturing a bumper beam unit for a vehicle and the bumper beam unit manufactured thereby having advantages of overcoming the limitations occurring when curvatures are formed through a bending process and achieving target crashworthiness of frontal sides of a vehicle body as a consequence of cutting out both end portions of a rear portion of a bumper beam and contacting and welding cutout surfaces.

Various exemplary embodiments of the present invention disclose a method of manufacturing a bumper beam unit of a vehicle. The method may include: a roll forming step in which a bumper beam of straight tubular shape is formed through a roll forming process; a curvature forming step in which the bumper beam is formed to have a predetermined curvature in a length direction thereof through a curvature former; a cutout section forming step in which a cutout section is formed by cutting out an end portion of a rear portion of the bumper beam partially; a cutout section bonding step in which a bonding section is formed by bonding both cutout surfaces in a state of contacting the both cutout surfaces; and a stay bonding step in which a stay is bonded to end portions of a rear surface of the bumper beam corresponding to the bonding section.

A distance between the both cutout surfaces of the cutout section may become wider toward a rear direction.

A vertical projection of the both cutout surfaces of the cutout section may have a V-shape.

The cutout section bonding step may be performed through CO2 welding.

The stay may be bonded to the bumper beam through a bracket formed corresponding to the bonding section in the stay bonding step.

Various exemplary embodiments of the present invention disclose a method of manufacturing a bumper beam unit of a vehicle, wherein the bumper beam unit includes a bumper beam formed through a roll forming process and a stay mounted at an end portion of the bumper beam. The method may include: a cutout section forming step in which a cutout section is formed by cutting out an end portion of a rear portion of the bumper beam partially; a cutout section bonding step in which a bonding section is formed by bonding both cutout surfaces in a state of contacting the both cutout surfaces; and a stay bonding step in which a stay is bonded to end portions of a rear surface of the bumper beam corresponding to the bonding section.

A distance between the both cutout surfaces of the cutout section may become wider toward a rear direction.

A vertical projection of the both cutout surfaces of the cutout section may have a V-shape.

The cutout section bonding step may be performed through CO2 welding.

The stay may be bonded to the bumper beam through a bracket formed corresponding to the bonding section in the stay bonding step.

Various exemplary embodiments of the present invention disclose a bumper beam unit manufactured by above-mentioned methods.

### BRIEF DESCRIPTION OF THE DRAWINGS

FIG. 1 is a perspective view of a conventional bumper beam unit for a vehicle.

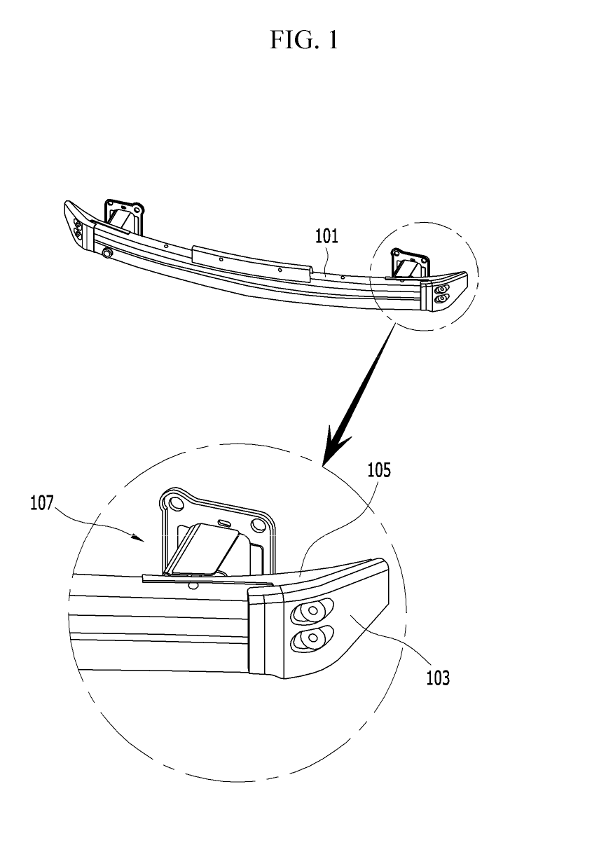

FIG. 2 is an exploded view of a conventional bumper beam unit for a vehicle.

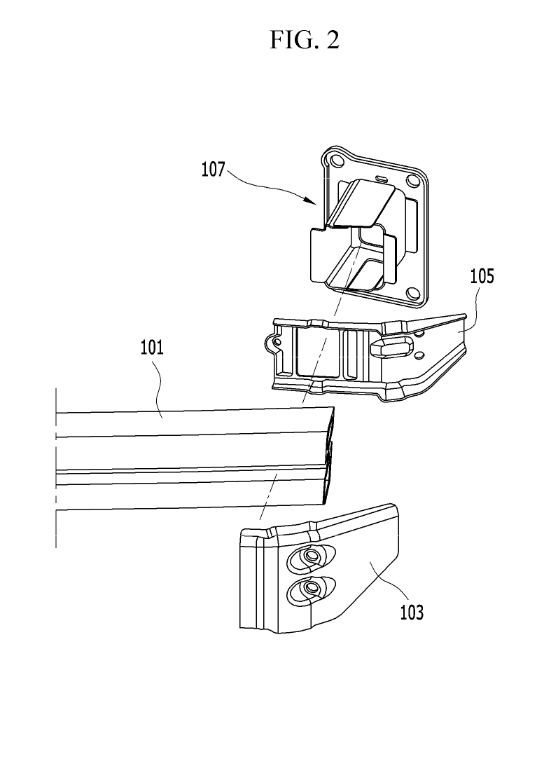

FIG. 3 is a flowchart of a method of manufacturing a bumper beam unit for a vehicle according to an exemplary embodiment of the present invention.

FIG. 4 is diagram for explaining a cutout section forming step in a method of manufacturing a bumper beam unit for a vehicle according to an exemplary embodiment of the present invention.

FIG. 5 is diagram for explaining a cutout section bonding step in a method of manufacturing a bumper beam unit for a vehicle according to an exemplary embodiment of the present invention.

FIG. 6 is diagram for explaining a stay bonding step in a method of manufacturing a bumper beam unit for a vehicle according to an exemplary embodiment of the present invention.

FIG. 7 is a perspective view of a bumper beam unit manufactured by a method of manufacturing a bumper beam unit for a vehicle according to an exemplary embodiment of the present invention.

<Description of symbols>

| | |
|---|---|
| 1: bumper beam | 3: cutout section |
| 5: cutout surface | 7: bracket |
| 9: stay | 11: bonding section |

### DETAILED DESCRIPTION OF THE EMBODIMENTS

An exemplary embodiment of the present invention will hereinafter be described in detail with reference to the accompanying drawings.

Size and thickness of components shown in the drawings may be differ from real size and real thickness of the components for better comprehension and ease of description, and thicknesses of some portions and regions are drawn with enlarged scale.

In addition, description of components which are not necessary for explaining the present invention will be omitted.

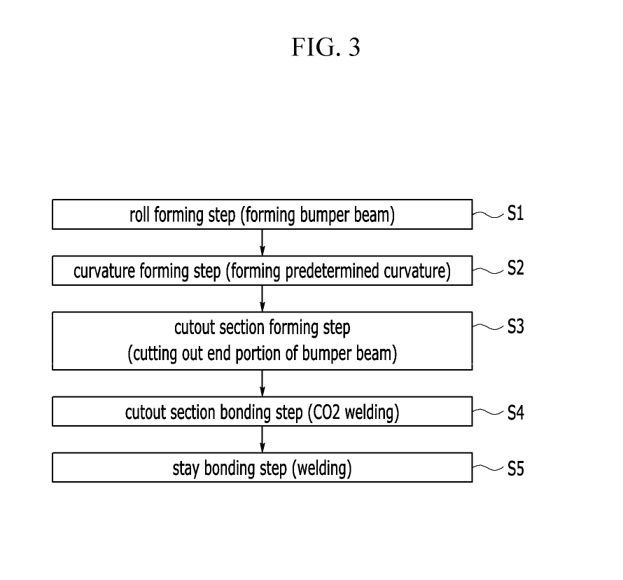

FIG. 3 is a flowchart of a method of manufacturing a bumper beam unit for a vehicle according to an exemplary embodiment of the present invention.

Referring to FIG. 3, a method of manufacturing a bumper beam unit of a vehicle includes a roll forming step S1, a curvature forming step S2, a cutout section forming step S3, a cutout section bonding step S4 and a stay bonding step S5.

A plate or a coil is continuously bent by a roll forming unit (not shown) including multiple roll formers in the roll forming step S1. Therefore, a bumper beam 1 of a straight tubular shape having a closed cross-section is formed in the roll forming step S1.

After the roll forming step S1 is completed, the curvature forming step S2 is performed.

The bumper beam 1 of the straight tubular shape is formed to have a predetermined curvature by a curvature former (not shown) so as to form the bumper beam 1 of a curved tubular shape in the curvature forming step S2.

After the curvature forming step S2 is completed, the cutout section forming step S3 is performed.

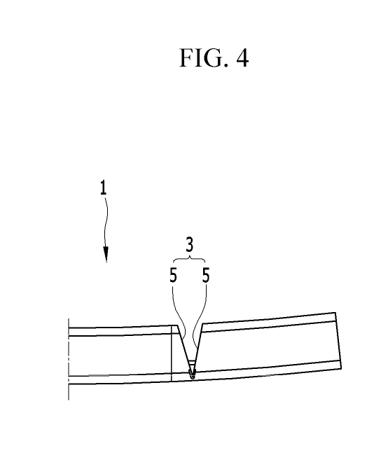

FIG. 4 is diagram for explaining a cutout section forming step in a method of manufacturing a bumper beam unit for a vehicle according to an exemplary embodiment of the present invention.

Referring to FIG. 4, both end portions of a rear portion of the bumper beam 1 having the curved tubular shape formed through the curvature forming step S2 are cut out partially so as to form cutout sections 3 in the cutout section forming step S3.

That is, the cutout sections 3 are formed by cutting out the both ends of the rear surface of the bumper beam 1 as well as upper and lower surfaces of the bumper beam 1. At this time, a vertical projection of both cutout surfaces 5 confronting each other has a V-shape. That is, a distance between the both cutout surfaces 5 becomes wider toward a rear direction.

After the cutout section forming step S3 is completed, the cutout section bonding step S4 is performed.

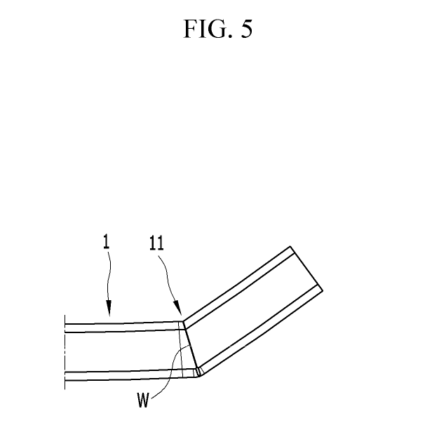

FIG. 5 is diagram for explaining a cutout section bonding step in a method of manufacturing a bumper beam unit for a vehicle according to an exemplary embodiment of the present invention.

Referring to FIG. 5, the both cutout surfaces 5 of the cutout section 3 are bonded together in the cutout section bonding step S4.

That is, the cutout section 3 is bonded by bending the end portion of the bumper beam 1 disposed at an outer portion from the cutout section 3 rearward so as to contact the both cutout surfaces 5 of each cutout section 3 and welding the both cutout surfaces 5. Therefore, a welded portion W is formed at a contacting portion of the both cutout surfaces 5 and a bonding section 11 is formed by welding the welded portion W. One or more bonding sections 11 may be formed at each end portion of the bumper beam 1.

At this time, the welded portion W may be formed by welding the both cutout surfaces 5 through CO2 welding, but the welding is not limited to the CO2 welding. That is, any method which can weld steel plates or aluminum plates in a state of being contacted may be used in the cutout section bonding step S4.

After the cutout section bonding step S4 is completed, the stay bonding step S5 is performed.

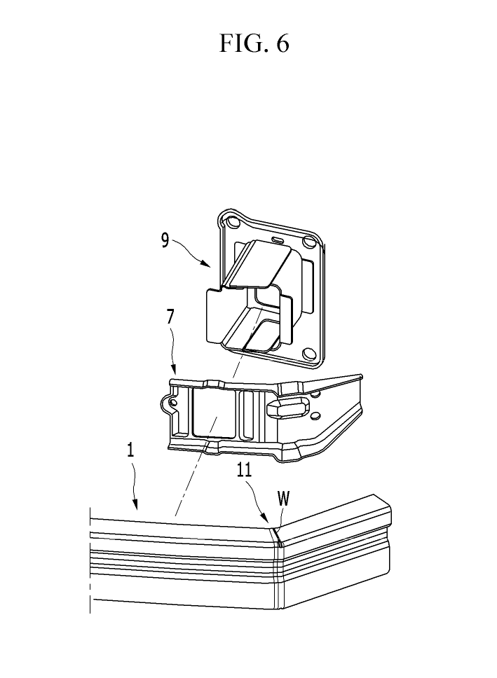

FIG. 6 is diagram for explaining a stay bonding step in a method of manufacturing a bumper beam unit for a vehicle according to an exemplary embodiment of the present invention.

Referring to FIG. 6, stays 9 are bonded to the both end portions of the rear surface of the bumper beam 1 in which bonding sections 11 are formed in the stay bonding step S5.

At this time, the stays 9 are bonded through the brackets 7 having shapes corresponding to the both end portions of the rear surface of the bumper beam 1 in which the bonding sections 11 are formed. That is, each bracket 7 is curved or bent to correspond to the end portion of the rear surface of the bumper beam 1.

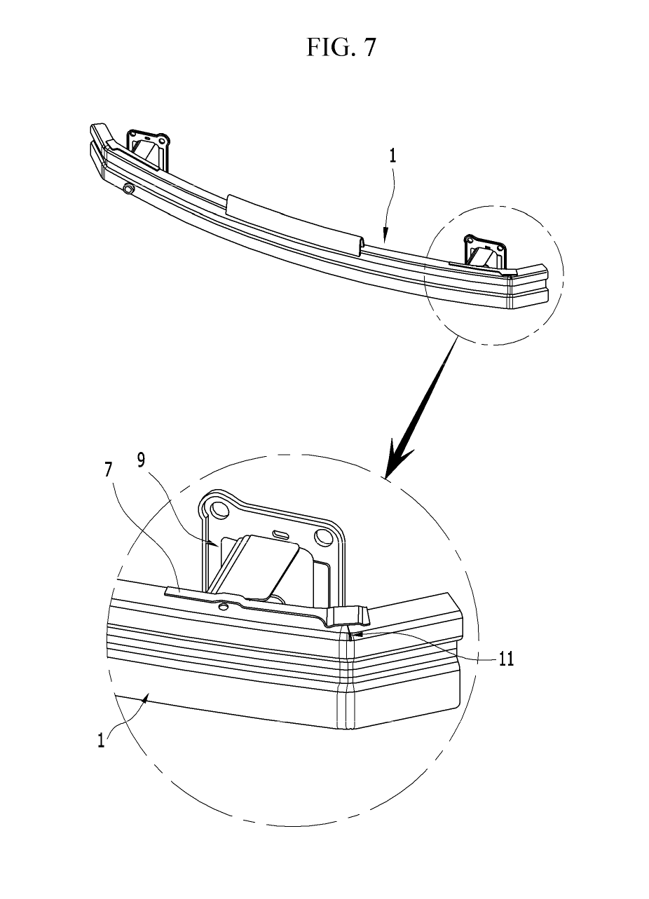

FIG. 7 is a perspective view of a bumper beam unit manufactured by a method of manufacturing a bumper beam unit for a vehicle according to an exemplary embodiment of the present invention.

Referring to FIG. 7, a bumper beam unit manufactured by the method according to the exemplary embodiment of the present invention includes the bumper beam 1 and the stay 9.

The bumper beam 1 has the predetermined curvature in the length direction thereof, and the both end portions of the bumper beam 1 are bent to the rear of the vehicle body through the bonding sections 11.

At this time, since a front surface of the bumper beam 1 is not cut out, strength of the bonding section 11 is maintained. In addition, the rear surface of the bumper beam 1 that is cut out may be reinforced by the bracket 7.

In addition, the stays 9 are bonded to the both end portions of the rear surface of the bumper beam 1.

At this time, the stays 9 are bonded to the both end portions of the rear surface of the bumper beam 1 through the brackets 7. Each bracket 7 corresponds to the end portion of the rear surface of the bumper beam 1 at which each bonding section 11 is formed.

The both end portions of the rear portion of the bumper beam 1 are partially cut out to form the cutout sections 3, and the both cutout surfaces 5 of each cutout section 3 are welded to form curvatures at both end portions of the bumper beam 1 in the method of manufacturing the bumper beam unit according to the exemplary embodiment of the present invention and the bumper beam unit manufactured thereby. Therefore, the limitations occurring in the conventional bending process may be overcome and the bumper beam 1 may be applied to the vehicle having a curved frontal side shape.

In addition, since the bonding sections 11 are formed by bending the both end portions of the bumper beam 1, strength of the bonding sections 11 of the bumper beam 1 may be sufficiently secured. Therefore, the bumper beam 1 may meet crash regulations such as frontal offset crash test, small overlap crash test, frontal side impact test, and so on.

In addition, since the front surface of the bumper beam 1 is not cut out and the bumper beam 1 is reinforced by the bracket 7 for mounting the stay 9, additional reinforcing members are not necessary. Therefore, manufacturing cost may be curtailed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of manufacturing a bumper beam unit of a vehicle, comprising:
a roll forming step in which a bumper beam of straight tubular shape is formed through a roll forming process;
a curvature forming step in which the bumper beam is formed to have a curvature in a length direction thereof corresponding to a front curved shape of the vehicle or a rear curved shape of the vehicle through a curvature former;
a cutout section forming step in which a cutout section is formed by cutting out an end portion of a rear portion of the bumper beam partially;
a cutout section bonding step in which a bonding section is formed by bonding both cutout surfaces in a state of contacting the both cutout surfaces; and
a stay bonding step in which a stay is bonded to end portions of a rear surface of the bumper beam corresponding to the bonding section.

2. The method of claim 1, wherein a distance between the both cutout surfaces of the cutout section becomes wider toward a rear direction.

3. The method of claim 1, wherein a vertical projection of the both cutout surfaces of the cutout section has a V-shape.

4. The method of claim 1, wherein the cutout section bonding step is performed through CO2 welding.

5. The method of claim 1, wherein the stay is bonded to the bumper beam through a bracket formed corresponding to the bonding section in the stay bonding step.

6. A method of manufacturing a bumper beam unit of a vehicle wherein the bumper beam unit includes a bumper beam formed through a roll forming process and a stay mounted at an end portion of the bumper beam, the method comprising:
a cutout section forming step in which a cutout section is formed by cutting out an end portion of a rear portion of the bumper beam partially;
a cutout section bonding step in which a bonding section is formed by bonding both cutout surfaces in a state of contacting the both cutout surfaces; and
a stay bonding step in which a stay is bonded to end portions of a rear surface of the bumper beam corresponding to the bonding section.

7. The method of claim 6, wherein a distance between the both cutout surfaces of the cutout section becomes wider toward a rear direction.

8. The method of claim 6, wherein a vertical projection of the both cutout surfaces of the cutout section has a V-shape.

9. The method of claim 6, wherein the cutout section bonding step is performed through CO2 welding.

10. The method of claim 6, wherein the stay is bonded to the bumper beam through a bracket formed corresponding to the bonding section in the stay bonding step.

11. A bumper beam unit manufactured by the method of claim 1.

12. A bumper beam unit manufactured by the method of claim 6.
